(19) United States
(12) Patent Application Publication
(10) Pub. No.: US 2021/0397959 A1
(43) Pub. Date: Dec. 23, 2021

(54) TRAINING REINFORCEMENT LEARNING AGENTS TO LEARN EXPERT EXPLORATION BEHAVIORS FROM DEMONSTRATORS

(71) Applicant: Google LLC, Mountain View, CA (US)

(72) Inventors: Olivier Claude Pietquin, Lille (FR); Léonard Hussenot Desenonges, Paris (FR); Robert Dadashi-Tazehozi, Paris (FR); Matthieu Florent Geist, Ancy-Dornot (FR)

(21) Appl. No.: 17/354,991

(22) Filed: Jun. 22, 2021

Related U.S. Application Data
(60) Provisional application No. 63/042,448, filed on Jun. 22, 2020.

(51) Int. Cl. G06N 3/08; G06N 3/04

(52) U.S. Cl. CPC G06N 3/08; G06N 3/0445; G06N 3/0454

(57) ABSTRACT

Methods, systems, and apparatus, including computer programs encoded on computer storage media, for training a neural network used to select actions performed by an agent interacting with an environment by performing actions that cause the environment to transition states. One of the methods includes obtaining a transition generated as a result of the reinforcement learning agent interacting with the environment, processing a bonus input using a bonus estimation neural network to generate an exploration bonus estimate that encourages the agent to explore the environment in accordance with an expert exploration strategy that would be adopted by an expert agent; generating a modified reward from the reward included in the transition and the exploration bonus estimate; and determining an update to current parameter values of the neural network to optimize a reinforcement learning objective function that maximizes returns to be received by the agent with respect to the modified reward.

### CROSS-REFERENCE TO RELATED APPLICATION

This application claims priority to U.S. Provisional Application No. 63/042,448, filed on Jun. 22, 2020. The disclosure of the prior application is considered part of and is incorporated by reference in the disclosure of this application.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that controls an agent using a control neural network system to perform one or more tasks.

In general, one innovative aspect of the subject matter described in this specification can be embodied in a method for training a neural network used to select actions performed by a reinforcement learning agent interacting with an environment by performing actions that cause the environment to transition states, the method comprising: obtaining a transition generated as a result of the reinforcement learning agent interacting with the environment, the transition comprising a current observation characterizing a current state of the environment, a current action performed by the agent in response to the current observation, and a reward received as a result of the agent performing the current action in response to the current observation; processing a bonus input comprising at least the current observation and the current action in the transition using a bonus estimation neural network having a plurality of bonus estimation network parameters and configured to process the bonus input to generate an exploration bonus estimate that encourages the agent to explore the environment in accordance with an exploration strategy that matches an expert exploration strategy that would be adopted by an expert agent; generating a modified reward from the reward included in the transition and the exploration bonus estimate generated by the bonus estimation neural network; and determining an update to current parameter values of the neural network to optimize a reinforcement learning objective function that maximizes returns to be received by the agent with respect to the modified reward.

The bonus input may further comprise a sequence of history observations up to the current observation of the environment and corresponding history actions performed by the agent that caused the environment to transition into each of the sequence of history observations.

Generating the modified reward from the reward included in the transition and the exploration bonus estimate generated by the bonus estimation neural network may comprise:

adding the exploration bonus estimate to the reward included in the transition.

Generating the modified reward from the reward included in the transition and the exploration bonus estimate generated by the bonus estimation neural network may comprise: determining a scaled exploration bonus estimate from the exploration bonus estimate by using an adjustable scaling factor; and adding the scaled exploration bonus estimate to the reward included in the transition.

The transition may further comprise a next observation characterizing a respective next state of the environment and a reward received in response to the agent performing the current action; the neural network may be configured to process the current observation and the current action included in the transition to output a Q value for the current action that is an estimate of a return that would be received if the agent performed the action in response to the current observation; the reinforcement learning objective function measures a difference between the Q value and a temporal difference (TD) learning target determined from the modified reward; and determining the update to current parameter values of the neural network to optimize the reinforcement learning objective function comprises determining a gradient of the reinforcement learning objective function with respect to the parameters of the neural network.

The temporal difference (TD) learning target may comprise a sum of (i) the reward included in the transition and (ii) a time-adjusted next expected return if a next action is performed in response to the next observation included in the transition.

The bonus estimation neural network may be a recurrent neural network.

Another innovative aspect of the subject matter described in this specification can be embodied in a method for training the bonus estimation neural network, the method comprising: obtaining one or more demonstrations each comprising a sequence of history observations up to a respective current observation and corresponding history actions for each of the history observations; for each of the one or more demonstrations: processing the demonstration and a ground truth action that has been selected from a set of possible actions that can be performed by the agent using the bonus estimation neural network and in accordance with current values of the bonus estimation network parameters to generate an exploration bonus estimate; determining a gradient of a bonus estimation loss function with respect to the bonus estimation network parameters, wherein the bonus estimation loss function includes a first term that measures a difference between the exploration bonus estimate and a target exploration bonus derived from a Q value for the ground truth action that is an estimate of a return that would be received if the agent performed the ground truth action in response to the current observation in the demonstration; and determining, from the gradient of the bonus estimation loss function, an update to the current values of the bonus estimation network parameters.

The bonus estimation loss function may include a second term that measures a difference between an adjustable bonus value and an exploration bonus estimate determined based on the agent performing a randomly sampled action in response to the current observation in the demonstration.

The ground truth action may be an action performed by an expert agent in response to the current observation in the demonstration.

The method may further comprise generating the Q value for the ground truth action by processing the current observation in the demonstration and the ground truth action using a policy neural network having a plurality of policy network parameters.

The method may further comprise training the policy neural network, the training comprising: for each of one or more second demonstrations: processing the second demonstration and each action in the set of possible actions using the policy neural network and in accordance with current values of the policy network parameters to generate respective Q values for the set of possible actions, each Q value being an estimate of a return that would be received if the agent performed a corresponding action in response to the current observation; determining a gradient of an action selection loss function with respect to the policy network parameters, wherein the action selection loss function includes a term that encourages that the Q value generated for a ground truth action to be increased; and determining, from the gradient of the action selection loss function, an update to the current values of the policy network parameters.

The policy neural network and the bonus estimation neural network may each be a respective recurrent neural network.

The ground truth action may be an action performed by an expert agent in response to the current observation.

The demonstrations, the second demonstrations, or both may be generated from interactions of an expert agent with a first environment.

The target exploration bonus derived from the Q value for the ground truth action may be based on: a difference between the Q value generated by the policy neural network for the ground truth action and a sum of (i) the reward specified by the demonstration and (ii) a time-adjusted next expected return if a next action is performed in response to the next observation specified by the demonstration.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages.

The disclosed techniques allow for training data from a replay memory to be utilized in a way that increases the value of the selected data for training a neural network used in selecting actions to be performed by agents when interacting with the environment. In particular, the disclosed techniques allow a system to learn to effectively estimate various intrinsic exploration bonuses from a set of expert demonstrations, and use the estimated exploration bonus to encourage the agent to explore the environment according to an exploration strategy that would be adopted by an expert demonstrator. In this way, the system can be trained to effectively select exploration actions (i.e., actions that cause the environment to transition into novel states which issue different returns to the agent) to be performed by the agent and thereby provide the RL training of the neural network with richer exploration signals.

Because exhaustive exploration of the environment is no longer encouraged, the system can largely avoid controlling the agent to enter useless or hazardous states of the environment resulting from performing randomly selected actions. Instead, only a relatively small number of expert exploratory actions will likely be performed by the agent during training. Compared with conventional epsilon-greedy exploration strategy and count-based methods, the system can perform more useful generalizations from training data and control the agent to make more structured exploration of various states of the environment.

The system can also maintain safety by avoiding selecting ostensibly hazardous actions that would likely cause damages to the agent itself, the environment, or another agent in the environment. This is particularly desirable in cases where the training involves controlling a mechanical agent (e.g., a robot) interacting with a real-world environment.

By incorporating the exploration bonus term into existing RL training schemes, including, for example, policy optimization-based or Q learning-based training, the described techniques can improve the effectiveness, efficiency, or both of training of neural networks used in selecting actions to be performed by agent. Thus, the amount of computing resources necessary for the training of the neural networks to achieve a desired level of performance can be reduced. For example, the amount of time required for training the neural network can be reduced, the amount of processing resources (e.g., memory, computing power, or both) used by the training process can be reduced, or both. The increased effectiveness in training of neural networks can be especially significant for training neural networks to select actions to be performed by agents interacting with complex environments, performing complex reinforcement learning tasks, or both.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for training an action selection neural network.

FIG. 3 is a flow diagram of an example process for training a bonus estimation neural network.

FIG. 4 is a flow diagram of an example process for training a policy neural network.

FIG. 5 is an example illustration of training an action selection neural network, a bonus estimation neural network, and a policy neural network.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent.

At each time step, the state of the environment at the time step depends on the state of the environment at the previous time step and the action performed by the agent at the previous time step.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., one or more of: images, object position data, and sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands, or the autonomous or semi-autonomous land, air, sea vehicle, e.g., torques to the control surface or other control elements e.g., steering control elements of the vehicle, or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g., steering, and movement e.g., braking and/or acceleration of the vehicle.

In the case of an electronic agent the observations may include data from one or more sensors monitoring part of a plant or service facility such as current, voltage, power, temperature and other sensors and/or electronic signals representing the functioning of electronic and/or mechanical items of equipment. For example the real-world environment may be a manufacturing plant or service facility, the observations may relate to operation of the plant or facility, for example to resource usage such as power consumption, and the agent may control actions or operations in the plant/facility, for example to reduce resource usage. In some other implementations the real-world environment may be a renewal energy plant, the observations may relate to operation of the plant, for example to maximize present or future planned electrical power generation, and the agent may control actions or operations in the plant to achieve this.

In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g., to adjust or turn on/off components of the plant/facility.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some implementations the environment may be a simulated environment and the agent may be implemented as one or more computers interacting with the simulated environment.

The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

In some implementations, the simulated environment may be a simulation of a particular real-world environment. For example, the system may be used to select actions in the simulated environment during training or evaluation of the control neural network and, after training or evaluation or both are complete, may be deployed for controlling a real-world agent in the real-world environment that is simulated by the simulated environment. This can avoid unnecessary wear and tear on and damage to the real-world environment or real-world agent and can allow the control neural network to be trained and evaluated on situations that occur rarely or are difficult to re-create in the real-world environment.

Generally, in the case of a simulated environment, the observations may include simulated versions of one or more of the previously described observations or types of observations and the actions may include simulated versions of one or more of the previously described actions or types of actions.

Optionally, in any of the above implementations, the observation at any given time step may include data from a previous time step that may be beneficial in characterizing the environment, e.g., the action performed at the previous time step, the reward received at the previous time step, and so on.

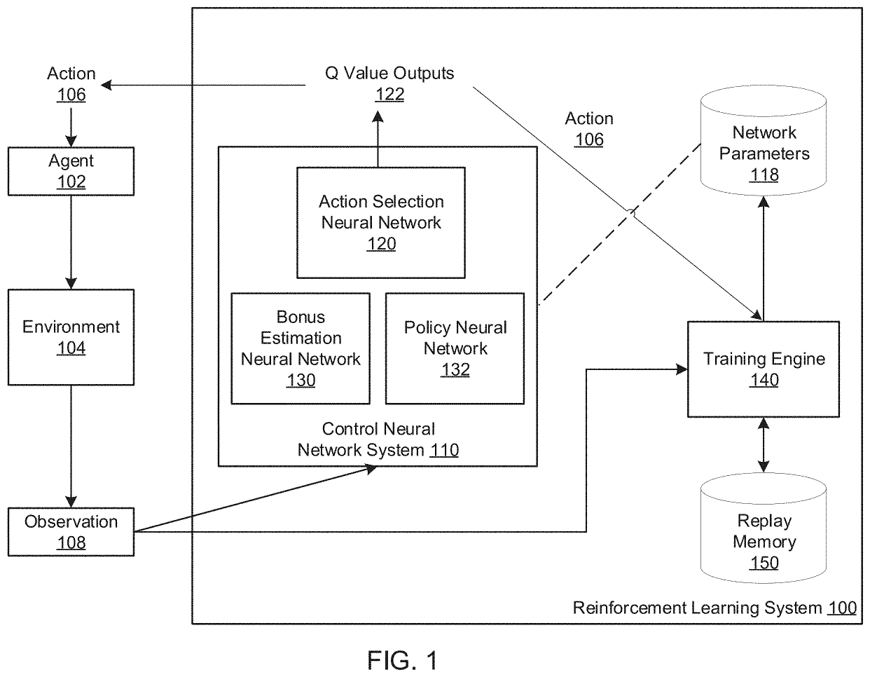

FIG. 1 shows an example reinforcement learning system 100. The reinforcement learning system 100 is an example of a system implemented as computer programs on one or more computers in one or more locations in which the systems, components, and techniques described below are implemented.

The system 100 controls an agent 102 interacting with an environment 104 by selecting actions 106 to be performed by the agent 102 and then causing the agent 102 to perform the selected actions 106.

Performance of the selected actions 106 by the agent 102 generally causes the environment 104 to transition into new states. By repeatedly causing the agent 102 to act in the environment 104, the system 100 can control the agent 102 to complete a specified task.

The system 100 includes a control neural network system 110 which includes an action selection neural network 120 and one or more storage devices storing the parameters 118 of the control neural network system 110.

At each of multiple time steps, the system 100 can use the action selection neural network 120 to process an input that includes the current observation 108 characterizing the current state of the environment 104 in accordance with the network parameters of the action selection neural network 120 to generate a respective Q value for each action in a set of possible actions that can be performed by the agent.

The action selection neural network 120 can be implemented with any appropriate neural network architecture that enables it to perform its described function. In one example, the action selection neural network 120 may include an “embedding” sub-network, a “core” sub-network, and a “selection” sub-network. A sub-network of a neural network refers to a group of one or more neural network layers in the neural network. When the observations are images, the embedding sub-network can be a convolutional sub-network, i.e., that includes one or more convolutional neural network layers, that is configured to process the observation for a time step. When the observations are lower-dimensional data, the embedding sub-network can be a fully-connected sub-network. The core sub-network can be a recurrent sub-network, e.g., that includes one or more long short-term memory (LSTM) neural network layers, that is configured to process the output of the embedding sub-network and action data defining each action from the set of possible actions (or data derived from the action data or both). The selection sub-network can be configured to process the output of the core sub-network to generate the Q value outputs for the actions.

The system 100 uses the Q values to control the agent, i.e., to select the action 106 to be performed by the agent at the current time step in accordance with an action selection policy and then cause the agent to perform the action 106, e.g., by directly transmitting control signals to the agent or by transmitting data identifying the action 106 to a control system for the agent.

The Q value for an action is an estimate of a “return” that would result from the agent performing the action in response to the current observation 108 and thereafter selecting future actions performed by the agent 102 in accordance with current values of the parameters of the action selection neural network.

A return refers to a cumulative measure of “rewards” received by the agent, for example, a time-discounted sum of rewards. The agent can receive a respective reward at each time step, where the reward is specified by a scalar numerical value and characterizes, e.g., a progress of the agent towards completing an assigned task.

In response to some or all of the actions performed by the agent 102, the reinforcement learning system 100 receives a reward. Each reward is a numeric value received from the environment 104 as a consequence of the agent performing an action, i.e., the reward will be different depending on the state that the environment 104 transitions into as a result of the agent 102 performing the action.

The system 100 can select the action to be performed by the agent based on the Q values generated by using the action selection neural network 120 using any of a variety of action selection policies, e.g., by selecting the action with the highest Q value or by mapping the Q values to probabilities and sampling an action in accordance with the probabilities.

To allow the agent to effectively interact with the environment, the reinforcement learning system 100 includes a training engine 140 that trains the action selection neural network 120 to determine trained values of the parameters of the action selection neural network 120 (referred to below as “action selection network parameters”).

The reinforcement learning system 100 maintains, e.g., at one or more storage devices that are accessible to the system, a replay memory 150 which stores pieces of experience data (referred to below as “transitions”) generated as a consequence of the interaction of the agent 102 (or another agent) with the environment 104 (or with another instance of the environment) for use in training the action selection neural network 120.

In some implementations, each transition is a tuple that includes: (1) a current observation sₜ characterizing the current state of the environment at one time, (2) a current action aₜ performed by the agent in response to the current observation, (3) a current reward rₜ received in response to the agent performing the current action, and (4) a next observation sₜ₊₁ characterizing the next state of the environment after the agent performs the current action, i.e., a state that the environment transitioned into as a result of the agent performing the current action.

In particular, the transitions constitute multiple “expert demonstrations.” Each expert demonstration includes a sequence of transitions generated by controlling the agent by an expert demonstrator such as a human or another, already trained machine learning system.

The training engine 140 trains the action selection neural network 120 by repeatedly selecting transitions from the replay memory 150 and training the action selection neural network 120 on the selected transitions.

Further, the training engine 140 makes use of a bonus estimation neural network 130 and a policy neural network 132 to assist in the training of the action selection neural network 120.

At a high level, the bonus estimation neural network 130 is a neural network having parameters (referred to below as “bonus estimation network parameters”) configured to process a bonus estimation network input including at least a current observation and a current action to generate an exploration bonus estimate. For example, the bonus estimation neural network 130 can be configured as a recurrent neural network which includes a recurrent layer (e.g., a long short-term memory (LSTM) layer) or a self-attention neural network that includes one or more self-attention layers, in addition to one or more fully-connected neural network layers and/or one or more convolutional neural network layers.

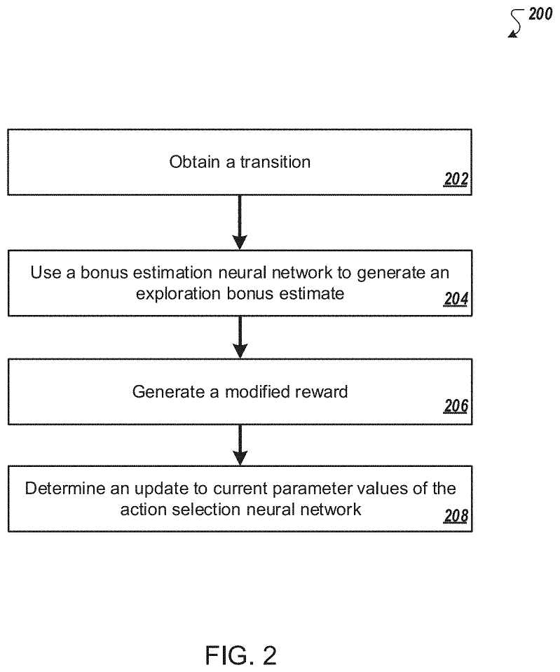

During the training of the system 100, the training engine 140 modifies the reward included in the selected transition (i.e., a reward received by the agent from the environment in response to performing each action) using the exploration bonus estimate and then trains the action selection neural network 120 by maximizing the returns to be received by the agent 106 with respect to the exploration bonus-adjusted reward, as will be described further below with reference to FIGS. 2-4.

The exploration bonus-adjusted reward encourages the agent to explore the environment during training by following an expert exploration strategy, i.e., an exploration strategy that would be adopted by an expert demonstrator when controlling the agent. Unlike conventional exploration policies such as epsilon-greedy exploration strategy and count-based methods, the exploration bonus-adjusted reward can effectuate more effective and structured exploration of various states of the environment being interacted with by the agent, thereby allowing for more useful generalizations from training data. The exploration bonus-adjusted reward can also avert selecting ostensibly hazardous actions that would likely cause damages to the agent itself or actions that may otherwise hinder successful training.

The training engine 140 also trains the policy neural network 132, i.e., determines trained values of parameters of the policy neural network (referred to below as “policy network parameters”), and uses the trained policy neural network to train the bonus estimation neural network 130 to accurately generate exploration bonus estimates for different actions.

At a high level, the policy neural network 132 is a neural network that has been configured through classification training to perform behavioral cloning of the expert demonstrator. In other words, once trained, the policy neural network 132 can be used to generate policy network outputs for different observations from which similar actions to the expert exploratory actions, i.e., exploratory actions that would be selected by the expert demonstrator when controlling the agent to interact with the environment, can be selected.

The policy neural network 132 can be configured to process a policy network input including at least a current observation and each action in a set of possible actions that can be performed by the agent to generate a policy network output that defines or otherwise specifies a respective target Q value for each action. For example, the architecture of the policy neural network 132 may include a recurrent layer (e.g., a LSTM layer), followed by a sequence of one or more fully-connected layers associated with an activation layer (e.g., a ReLU activation layer), and an output layer that generates the policy network output.

FIG. 2 is a flow diagram of an example process 200 for training an action selection neural network. For convenience, the process 200 will be described as being performed by a system of one or more computers located in one or more locations. For example, a system, e.g., the reinforcement learning system 100 of FIG. 1, appropriately programmed, can perform the process 200.

The system obtains a transition from a replay memory (202) which stores a plurality of transitions generated as a result of the reinforcement learning agent interacting with the environment. The system can obtain the transition through either random or prioritized sampling, e.g., based on the value of an associated temporal difference learning error or some other learning progress measure.

In some implementations, the transition is a tuple that includes: (1) a current observation sₜ characterizing the current state of the environment at one time, (2) a current action aₜ performed by the agent in response to the current observation, (3) a current reward rₜ received in response to the agent performing the current action, and (4) a next observation sₜ₊₁ characterizing the next state of the environment after the agent performs the current action, i.e., a state that the environment transitioned into as a result of the agent performing the current action.

The system processes a bonus input using a bonus estimation neural network to generate an exploration bonus estimate (204). The bonus input includes (i) the current observation in the transition, (ii) the current action in the transition, and, optionally, (iii) a sequence of history observations up to the current observation of the environment and corresponding history actions performed by the agent that caused the environment to transition into each of the sequence of history observations.

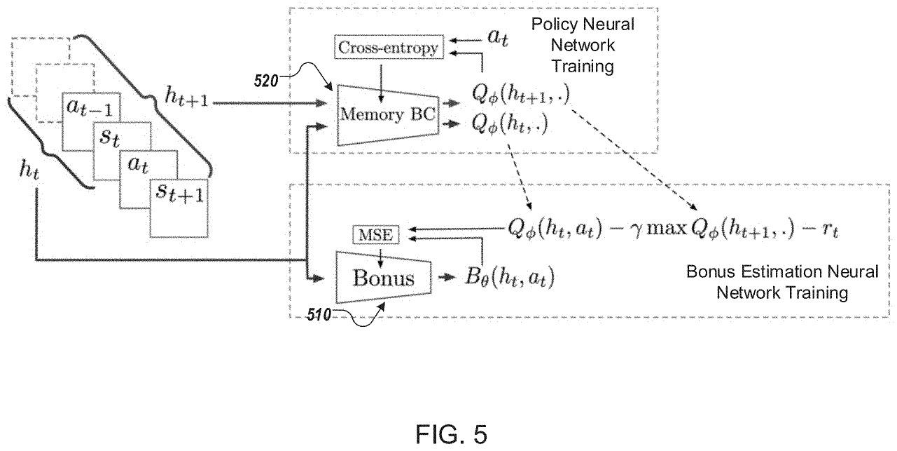

FIG. 5 is an example illustration of training an action selection neural network, a bonus estimation neural network, and a policy neural network. As illustrated in FIG. 5, the bonus estimation neural network 510 is configured to receive as input (hₜ, aₜ) and to process the input in accordance with current values of the bonus estimation network parameters θ to generate an exploration bonus estimate B_{θ}(hₜ, aₜ), where aₜ is the current action in the transition, and hₜ=(s₀, a₀, . . . , sₜ₋₁, aₜ₋₁, sₜ) includes the current observation sₜ, the sequence of history observations s₀-sₜ₋₁ up to the current observation of the environment and corresponding history actions a₀-aₜ₋₁ performed by the agent that caused the environment to transition into each of the sequence of history observations.

For example, when configured as a recurrent neural network, the system can use the bonus estimation neural network to receive a current input (sₜ, aₜ) and to update a current hidden state of the bonus estimation neural network generated by processing the sequence of history observations s₀-sₜ₋₁ and the corresponding history actions a₀-aₜ₋₁, i.e., to modify the current hidden state of the bonus estimation neural network that has been generated by processing the sequence of history observations and the corresponding history actions by processing the current input which includes the current observation and the current action. The system can then use the updated hidden state to generate a current output which specifies the exploration bonus estimate B (hₜ, aₜ).

The system generates a modified reward from the reward included in the transition and the exploration bonus estimate generated by the bonus estimation neural network (206).

Specifically, the system can generate the modified reward M_R by running a user-specified combination function over the exploration bonus estimate and the reward included in the transition: M_R=f_{combine}(B(h, a), R(s, a)). For example, the system can generate the modified reward by determining a sum of the exploration bonus estimate and the reward included in the transition: M_R=B(h, a)+R(s, a), i.e., by adding the exploration bonus estimate to the reward included in the transition. Alternatively, the system can generate the modified reward by determining a scaled exploration bonus estimate from the exploration bonus estimate, e.g., by multiplying the exploration bonus estimate with an adjustable scaling factor, and then adding the scaled exploration bonus estimate to the reward included in the transition.

The system determines an update to current parameter values of the action selection neural network to optimize a reinforcement learning objective function that maximizes returns to be received by the agent with respect to the modified reward (208).

For example, the reinforcement learning objective function can include a temporal difference (TD) learning target that is determined from the modified reward. Mathematically, the temporal difference (TD) learning target determined from the modified reward can be computed as:

M_R+ [symbol] _{s′|s,a}[ [symbol] _{ϕ}(h′,π_{ϕ}(h′))],

where ϕ denotes the set of policy network parameters, [symbol] _{s′|s,a}[ [symbol] _{ϕ}(h′, π_{ϕ}(h′))] is a (time-adjusted) next expected return if a next action is performed in response to the next observation included in the transition, and M_R is the modified reward, which may be computed as R(s, a)+B(h, a), where B(h, a) is the exploration bonus estimate generated by the bonus estimation neural network, R(s, a) is the reward included in the transition

The manner in which the system selects the next action π_{ϕ}(h′)=argmaxₐ_{ₜ₊₁}Q_{ϕ}(h′, aₜ₊₁) and determines the next expected return is dependent on the reinforcement learning algorithm being used to train the neural networks. For example, in a deep Q learning technique, the system selects as the next action aₜ₊₁ the action that, when provided as input to the policy neural network in combination with the next observation and, in some cases, the current observation plus a sequence of history observations up to the current observation of the environment and corresponding history actions performed by the agent that caused the environment to transition into each of the sequence of history observations, results in the policy neural network outputting the highest Q value and uses the Q value for the next action that is generated by the policy neural network as the next return. Additionally or alternatively, the (time-adjusted) next expected return can be computed by the system as a weighted sum of estimated returns that would be received by the agent if the agent performed each next action from the set of possible next actions in response to the next observation included in the transition, where respective weights of the estimated returns are determined according to the respective Q values generated for the set of possible next actions by using the policy neural network.

As illustrated in the example of FIG. 5, the policy neural network 520 is configured to receive as input (i) hₜ₊₁, which includes the next observation sₜ₊₁, the sequence of history observations up to the next observation of the environment s₀-sₜ and corresponding history actions a₀-aₜ performed by the agent that caused the environment to transition into each of the sequence of history observations and (ii) an action from a set of possible actions that can be performed by the agent in response to the next observation, and to process the input in accordance with current values of the bonus estimation network parameters ϕ to generate a policy network output which specifies a Q value Q for the action.

For example, when configured as a recurrent neural network, the system can use the policy neural network to receive a current input (sₜ₊₁, aₜ₊₁) which includes the next observation and an action from the set of possible actions that can be performed by the agent in response to the next observation and to update a current hidden state of the policy neural network generated by processing the sequence of history observations s₀-sₜ up to the next observation and the corresponding history actions a₀-aₜ, i.e., to modify the current hidden state of the policy neural network that has been generated by processing the sequence of history observations and the corresponding history actions by processing the current input. The system can then use the updated hidden state to generate as output the Q value for the action.

In other words, to determine the TD learning target for the transition, the system can process the next observation and each action in a set of possible next actions that can be performed by the agent in response to the next observation using the policy neural network to generate a respective Q value for the next action that is an estimate of a return that would be received if the agent performed the next action in response to the next observation. The system then selects, by using the respective Q values for the set of possible next actions, the next action to be performed by the agent in response to the next observation.

In this example, the reinforcement learning objective function can measure a difference between (i) a current Q value for the transition and (ii) the temporal difference (TD) learning target that has been determined from the modified reward, i.e., M_R+ [symbol] _{s′|s,a}[ [symbol] _{ϕ}(h′, π_{ϕ}(h′))]. To generate the current Q value for the transition, the system can process the current observation and the current action included in the transition by using the action selection neural network in accordance with current values of the action selection network parameters. As described above, the current Q value is a current expected return as determined by the system if the current action in the transition is performed in response to the current observation in the transition.

To determine the update to current parameter values of the action selection neural network, the system computes a gradient of the reinforcement learning objective function with respect to the action selection network parameters, e.g., through backpropagation.

The system can then proceed to adjust the current parameter values of the action selection neural network by applying an update rule to the gradient, e.g., a stochastic gradient descent update rule, an Adam optimizer update rule, an rmsProp update rule, or a learned update rule that is specific to the training of the action selection neural network. Alternatively, the system only proceeds to update the current parameter values once the process 200 has been performed for an entire batch of transitions. A batch generally includes a fixed number of transitions, e.g., 2, 4, or 8. In other words, the system combines, e.g., by computing a weighted or unweighted average of, respective gradients that are determined during the fixed number of iterations of process 200 and proceeds to update the current values of the action selection network parameters based on the combined gradient.

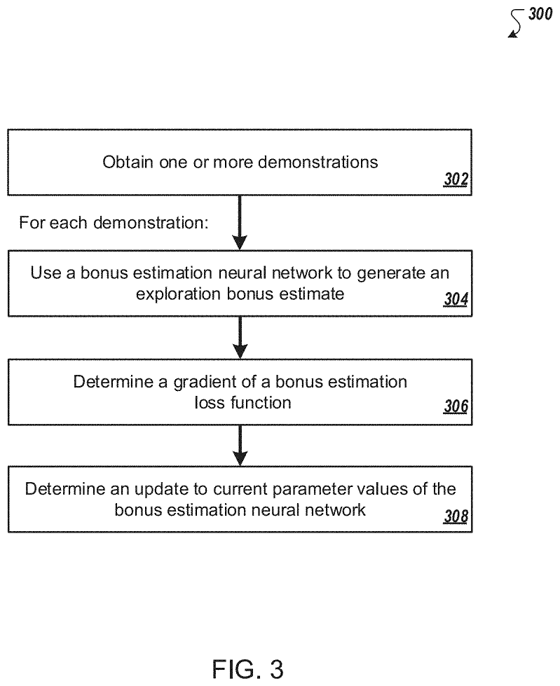

FIG. 3 is a flow diagram of an example process 300 for training a bonus estimation neural network. For convenience, the process 300 will be described as being performed by a system of one or more computers located in one or more locations. For example, a system, e.g., the reinforcement learning system 100 of FIG. 1, appropriately programmed, can perform the process 300.

The system obtains one or more demonstrations that each includes a sequence of history observations up to a respective current observation and corresponding history actions for each of the history observations (302). The system can obtain, e.g., through random sampling, the one or more demonstrations from the replay memory storing the plurality of transitions, each of which including at least (1) a current observation sₜ characterizing the current state of the environment at one time (2) a current action aₜ performed by the agent in response to the current observation.

To train the bonus estimation neural network on the one or more demonstrations, the system can repeatedly perform the followings steps 304-308 for each demonstration of the one or more demonstrations.

The system processes the demonstration and a ground truth action that has been selected from a set of possible actions that can be performed by the agent using the bonus estimation neural network and in accordance with current values of the bonus estimation network parameters to generate an exploration bonus estimate (304). In particular, the ground truth action is an action from the set of possible actions that is actually performed by an expert agent in response to the current observation in the demonstration. For example, the expert agent can be an agent interacting with the environment that is controlled by a human or another, already trained machine learning system.

The system evaluates a bonus estimation loss function includes a first term that measures a difference, e.g., a mean squared error (MSE) difference, between the exploration bonus estimate and a target exploration bonus derived from a Q value for the ground truth action that is an estimate of a return that would be received if the agent performed the ground truth action in response to the current observation in the demonstration. The target exploration bonus derived from the Q value for the ground truth action can be based on a difference between the Q value generated by a policy neural network having a plurality of policy network parameters for the ground truth action and a sum of (i) the reward specified by the demonstration and (ii) a (time-adjusted) next expected return if a next action is performed in response to the next observation specified by the demonstration.

As similarly described above with reference to step 208 in FIG. 2, the system can determine the Q value for the ground truth action by processing the current observation in the demonstration and the ground truth action using the policy neural network. The system can also determine the next expected return based on processing the next observation and ground truth next action using the policy neural network (or a target instance of the policy neural network, which has the same architecture as the policy neural network but may have different parameter values) to generate a Q value for the next ground truth action and use this Q value as an estimate of a return that would be received if the agent performed the next ground truth action in response to the next observation. The next ground truth action is an action from the set of possible actions that is actually performed by the expert agent in response to the next observation in the demonstration.

The bonus estimation loss function also includes a second term that measures a difference, e.g., a MSE difference, between an adjustable bonus value and an exploration bonus estimate determined based on the agent performing a randomly sampled action in response to the current observation in the demonstration.

In one example, the system can evaluate the bonus estimation loss function by computing:

$${reg}^{} = {( {Q}_{ϕ} ( {h}_{E} , {a}_{E} ) - {YQ}_{ϕ} ( {h}_{E}^{′} , {π}_{ϕ} ( {h}_{E}^{′} ) ) - R ( {s}_{E} , {a}_{E} ) - {B}_{θ} ( {h}_{E} , {a}_{E} ) )}^{2} + {( {B}_{min} - {B}_{θ} ( {h}_{E} , \overline{{a}_{E}} ) )}^{2} .$$

In this example, B_{θ}(h_{E}, a_{E}) is the exploration bonus estimate for the ground truth action a_{E}, [symbol] _{ϕ}(h_{E}, a_{E})−γ [symbol] _{ϕ}(h_{E}′, π_{ϕ}(h_{E}′))−R(s_{E}, a_{E}) is the target exploration bonus, i.e., the difference between the Q value generated by using the policy neural network for the ground truth action and a sum of (i) the reward R (h_{E}, a_{E}) as specified by the demonstration and (ii) a time-adjusted next expected return if a next action is performed in response to the next observation specified by the demonstration, as similarly generated by using the policy neural network, where γ a time-discount factor. Bₘᵢₙ, which can be computed as a minimum over transitions included in the replay memory as min( [symbol] _{ϕ}(h_{E}, a_{E})−γ [symbol] _{ϕ}(h_{E}′, π_{ϕ}(h_{E}′))−R(s_{E}, a_{E})) is the adjustable bonus value. B_{θ}(h_{E}, a̅_̅{̅E̅}̅) is the exploration bonus estimate determined based on the agent performing an action a̅_̅{̅E̅}̅ which has been randomly sampled from the set of possible actions in response to the current observation in the demonstration

The system determines a gradient of the bonus estimation loss function with respect to the bonus estimation network parameters (306), e.g., through backpropagation.

The system determines an update to the current values of the bonus estimation network parameters (308) based on the gradient of the bonus estimation loss function and then applies the update, e.g., by applying an update rule to the gradient, e.g., a stochastic gradient descent update rule, an Adam optimizer update rule, an rmsProp update rule, or a learned update rule that is specific to the training of the bonus estimation neural network.

The system also trains the policy neural network on one or more second demonstrations obtained from the replay memory that each includes a sequence of history observations up to a respective current observation and corresponding history actions for each of the history observations, so as to determine trained values of the policy network parameters.

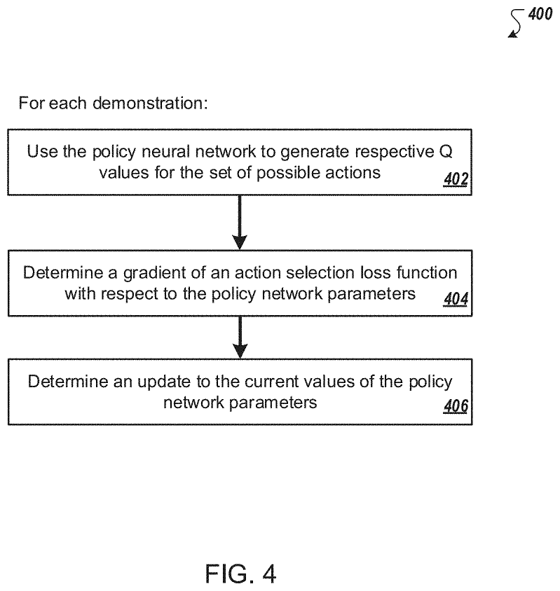

FIG. 4 is a flow diagram of an example process 400 for training a policy neural network. For convenience, the process 400 will be described as being performed by a system of one or more computers located in one or more locations. For example, a system, e.g., the reinforcement learning system 100 of FIG. 1, appropriately programmed, can perform the process 400.

To train the policy neural network on the one or more second demonstrations, the system can repeatedly perform the followings steps 402-406 for each demonstration of the one or more second demonstrations.

The system processes the second demonstration and each action in the set of possible actions using the policy neural network and in accordance with current values of the policy network parameters to generate respective Q values for the set of possible actions (402). Each Q value is an estimate of a return that would be received if the agent performed a corresponding action in response to the current observation.

The system evaluates an action selection loss function that includes a term that encourages that the Q value generated for a ground truth action to be increased. For example, the system can evaluate the action selection loss function by computing a cross-entropy loss:

[symbol]

^{BC}=ln(softmax( [symbol] _{ϕ}(h_{E},a_{E})),

where the softmax operator is evaluated over the set of possible actions, among which a_{E} is the ground truth action.

The system determines, e.g., through backpropagation, a gradient of the action selection loss function with respect to the policy network parameters (404).

The system determines an update to the current values of the policy network parameters (406) based on the gradient of the action selection loss function, and then applies the update, e.g., by applying an update rule to the gradient, e.g., a stochastic gradient descent update rule, an Adam optimizer update rule, an rmsProp update rule, or a learned update rule that is specific to the training of the policy neural network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a neural network used to select actions performed by a reinforcement learning agent interacting with an environment by performing actions that cause the environment to transition states, the method comprising:
obtaining a transition generated as a result of the reinforcement learning agent interacting with the environment, the transition comprising a current observation characterizing a current state of the environment, a current action performed by the agent in response to the current observation, and a reward received as a result of the agent performing the current action in response to the current observation;
processing a bonus input comprising at least the current observation and the current action in the transition using a bonus estimation neural network having a plurality of bonus estimation network parameters and configured to process the bonus input to generate an exploration bonus estimate that encourages the agent to explore the environment in accordance with an exploration strategy that matches an expert exploration strategy that would be adopted by an expert agent;
generating a modified reward from the reward included in the transition and the exploration bonus estimate generated by the bonus estimation neural network; and
determining an update to current parameter values of the neural network to optimize a reinforcement learning objective function that maximizes returns to be received by the agent with respect to the modified reward.

2. The method of claim 1, wherein the bonus input further comprises a sequence of history observations up to the current observation of the environment and corresponding history actions performed by the agent that caused the environment to transition into each of the sequence of history observations.

3. The method of claim 1, wherein generating the modified reward from the reward included in the transition and the exploration bonus estimate generated by the bonus estimation neural network comprises:
adding the exploration bonus estimate to the reward included in the transition.

4. The method of claim 1, wherein generating the modified reward from the reward included in the transition and the exploration bonus estimate generated by the bonus estimation neural network comprises:
determining a scaled exploration bonus estimate from the exploration bonus estimate by using an adjustable scaling factor; and
adding the scaled exploration bonus estimate to the reward included in the transition.

5. The method of claim 1, wherein:
the transition further comprises a next observation characterizing a respective next state of the environment and a reward received in response to the agent performing the current action;
the neural network is configured to process the current observation and the current action included in the transition to output a Q value for the current action that is an estimate of a return that would be received if the agent performed the action in response to the current observation;
the reinforcement learning objective function measures a difference between the Q value and a temporal difference (TD) learning target determined from the modified reward; and
determining the update to current parameter values of the neural network to optimize the reinforcement learning objective function comprises determining a gradient of the reinforcement learning objective function with respect to the parameters of the neural network.

6. The method of claim 5, wherein the temporal difference (TD) learning target comprises a sum of (i) the reward included in the transition and (ii) a time-adjusted next expected return if a next action is performed in response to the next observation included in the transition.

7. The method of claim 1, wherein the bonus estimation neural network is a recurrent neural network.

8. The method of claim 1, further comprising training the bonus estimation neural network, wherein the training comprises:
obtaining one or more demonstrations each comprising a sequence of history observations up to a respective current observation and corresponding history actions for each of the history observations;
for each of the one or more demonstrations:
processing the demonstration and a ground truth action that has been selected from a set of possible actions that can be performed by the agent using the bonus estimation neural network and in accordance with current values of the bonus estimation network parameters to generate an exploration bonus estimate;
determining a gradient of a bonus estimation loss function with respect to the bonus estimation network parameters, wherein the bonus estimation loss function includes a first term that measures a difference between the exploration bonus estimate and a target exploration bonus derived from a Q value for the ground truth action that is an estimate of a return that would be received if the agent performed the ground truth action in response to the current observation in the demonstration; and
determining, from the gradient of the bonus estimation loss function, an update to the current values of the bonus estimation network parameters.

9. The method of claim 8, wherein the bonus estimation loss function includes a second term that measures a difference between an adjustable bonus value and an exploration bonus estimate determined based on the agent performing a randomly sampled action in response to the current observation in the demonstration.

10. The method of claim 8, wherein the ground truth action is an action performed by an expert agent in response to the current observation in the demonstration.

11. The method of claim 8, further comprising:
generating the Q value for the ground truth action by processing the current observation in the demonstration and the ground truth action using a policy neural network having a plurality of policy network parameters.

12. The method of claim 11, further comprising training the policy neural network, wherein the training comprises:
for each of one or more second demonstrations:
processing the second demonstration and each action in the set of possible actions using the policy neural network and in accordance with current values of the policy network parameters to generate respective Q values for the set of possible actions, each Q value being an estimate of a return that would be received if the agent performed a corresponding action in response to the current observation;
determining a gradient of an action selection loss function with respect to the policy network parameters, wherein the action selection loss function includes a term that encourages that the Q value generated for a ground truth action to be increased; and
determining, from the gradient of the action selection loss function, an update to the current values of the policy network parameters.

13. The method of claim 12, wherein the policy neural network and the bonus estimation neural network are each a respective recurrent neural network.

14. The method of claim 12, wherein the ground truth action is an action performed by an expert agent in response to the current observation.

14. The method of claim 8, wherein the demonstrations, the second demonstrations, or both are generated from interactions of an expert agent with a first environment.

15. The method of claim 8, wherein the target exploration bonus derived from the Q value for the ground truth action is based on:
a difference between the Q value generated by the policy neural network for the ground truth action and a sum of (i) the reward specified by the demonstration and (ii) a time-adjusted next expected return if a next action is performed in response to the next observation specified by the demonstration.

16. One or more computer-readable storage media storing instructions that when executed by one or more computers cause the one or more computers to perform operations for training a neural network used to select actions performed by a reinforcement learning agent interacting with an environment by performing actions that cause the environment to transition states, the operations comprising:
obtaining a transition generated as a result of the reinforcement learning agent interacting with the environment, the transition comprising a current observation characterizing a current state of the environment, a current action performed by the agent in response to the current observation, and a reward received as a result of the agent performing the current action in response to the current observation;
processing a bonus input comprising at least the current observation and the current action in the transition using a bonus estimation neural network having a plurality of bonus estimation network parameters and configured to process the bonus input to generate an exploration bonus estimate that encourages the agent to explore the environment in accordance with an exploration strategy that matches an expert exploration strategy that would be adopted by an expert agent;
generating a modified reward from the reward included in the transition and the exploration bonus estimate generated by the bonus estimation neural network; and
determining an update to current parameter values of the neural network to optimize a reinforcement learning objective function that maximizes returns to be received by the agent with respect to the modified reward.

17. A system comprising one or more computers and one or more storage devices storing instructions that when executed by one or more computers cause the one or more computers to perform operations for training a neural network used to select actions performed by a reinforcement learning agent interacting with an environment by performing actions that cause the environment to transition states, the operations comprising:
obtaining a transition generated as a result of the reinforcement learning agent interacting with the environment, the transition comprising a current observation characterizing a current state of the environment, a current action performed by the agent in response to the current observation, and a reward received as a result of the agent performing the current action in response to the current observation;
processing a bonus input comprising at least the current observation and the current action in the transition using a bonus estimation neural network having a plurality of bonus estimation network parameters and configured to process the bonus input to generate an exploration bonus estimate that encourages the agent to explore the environment in accordance with an exploration strategy that matches an expert exploration strategy that would be adopted by an expert agent;
generating a modified reward from the reward included in the transition and the exploration bonus estimate generated by the bonus estimation neural network; and
determining an update to current parameter values of the neural network to optimize a reinforcement learning objective function that maximizes returns to be received by the agent with respect to the modified reward.

18. The system of claim 17, wherein:
the transition further comprises a next observation characterizing a respective next state of the environment and a reward received in response to the agent performing the current action;
the neural network is configured to process the current observation and the current action included in the transition to output a Q value for the current action that is an estimate of a return that would be received if the agent performed the action in response to the current observation;
the reinforcement learning objective function measures a difference between the Q value and a temporal difference (TD) learning target determined from the modified reward; and
determining the update to current parameter values of the neural network to optimize the reinforcement learning objective function comprises determining a gradient of the reinforcement learning objective function with respect to the parameters of the neural network.

19. The system of claim 17, wherein the operations further comprise training the bonus estimation neural network, and wherein the training comprises:
obtaining one or more demonstrations each comprising a sequence of history observations up to a respective current observation and corresponding history actions for each of the history observations;
for each of the one or more demonstrations:
processing the demonstration and a ground truth action that has been selected from a set of possible actions that can be performed by the agent using the bonus estimation neural network and in accordance with current values of the bonus estimation network parameters to generate an exploration bonus estimate;
determining a gradient of a bonus estimation loss function with respect to the bonus estimation network parameters, wherein the bonus estimation loss function includes a first term that measures a difference between the exploration bonus estimate and a target exploration bonus derived from a Q value for the ground truth action that is an estimate of a return that would be received if the agent performed the ground truth action in response to the current observation in the demonstration; and
determining, from the gradient of the bonus estimation loss function, an update to the current values of the bonus estimation network parameters.

20. The system of claim 19, wherein the operations further comprise training the policy neural network, and wherein the training comprises:
for each of one or more second demonstrations:
processing the second demonstration and each action in the set of possible actions using the policy neural network and in accordance with current values of the policy network parameters to generate respective Q values for the set of possible actions, each Q value being an estimate of a return that would be received if the agent performed a corresponding action in response to the current observation;
determining a gradient of an action selection loss function with respect to the policy network parameters, wherein the action selection loss function includes a term that encourages that the Q value generated for a ground truth action to be increased; and
determining, from the gradient of the action selection loss function, an update to the current values of the policy network parameters.
